(19) United States
(12) Patent Application Publication
(10) Pub. No.: US 2014/0106125 A1
(43) Pub. Date: Apr. 17, 2014

(54) TOUCH PANEL SHEET

(71) Applicant: Kabushiki Kaisha Tokai Rika Denki Seisakusho, Aichi (JP)

(72) Inventor: Mikio TATAI, Aichi (JP)

(73) Assignee: KABUSHIKI KAISHA TOKAI RIKA DENKI SEISAKUSHO, Aichi (JP)

(21) Appl. No.: 14/044,323

(22) Filed: Oct. 2, 2013

(30) Foreign Application Priority Data
Oct. 16, 2012 (JP) 2012-229003

(51) Int. Cl. G06F 3/041

(52) U.S. Cl. CPC G06F 3/041
USPC 428/143

(57) ABSTRACT

A touch panel includes a base sheet and an irregular printed sheet, which is arranged above the base sheet. The irregular printed layer includes an ink printed surface that serves as an irregular surface on which a finger is dragged. The ink printed surface contains beads.

### CROSS-REFERENCE TO RELATED APPLICATIONS

This application is based upon and claims the benefit of priority from prior Japanese Patent Application No. 2012-229003, filed on Oct. 16, 2012, the entire contents of which are incorporated herein by reference.

### FIELD

The present invention relates to a touch panel sheet.

### BACKGROUND

Japanese Laid-Open Patent Publication No. 2010-153298 describes an example of a touch panel used to operate an electrical device. The touch panel includes a resin sheet arranged on a portion touched by a user.

The resin sheet is textured by fine irregularities to improve the dragging feel of the touch panel. The texturing reduces the area of contact between the resin sheet and the finger of a user. This allows for smooth dragging of the finger on the touch panel.

A mold is used to form the resin sheet. However, the formation of fine irregularities with a mold is difficult. Further, when a mold includes fine irregularities, the adhesiveness increases between the metal mold and the resin sheet. However, the resin sheet may be molded without resin completely entering between the irregularities of the mold. In such a case, the irregularities would not be completely transferred from the mold to the resin sheet. This adversely affects the dragging feel of the touch panel.

### SUMMARY

One aspect of the present invention is a touch panel sheet including a base sheet and an irregular printed sheet, which is arranged above the base sheet. The irregular printed layer includes an irregular surface on which a finger may be dragged, and the ink printed surface contains beads.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which

FIG. 1 is a cross-sectional diagram of a touch panel sheet according to one embodiment of the present invention.

### DESCRIPTION OF THE EMBODIMENTS

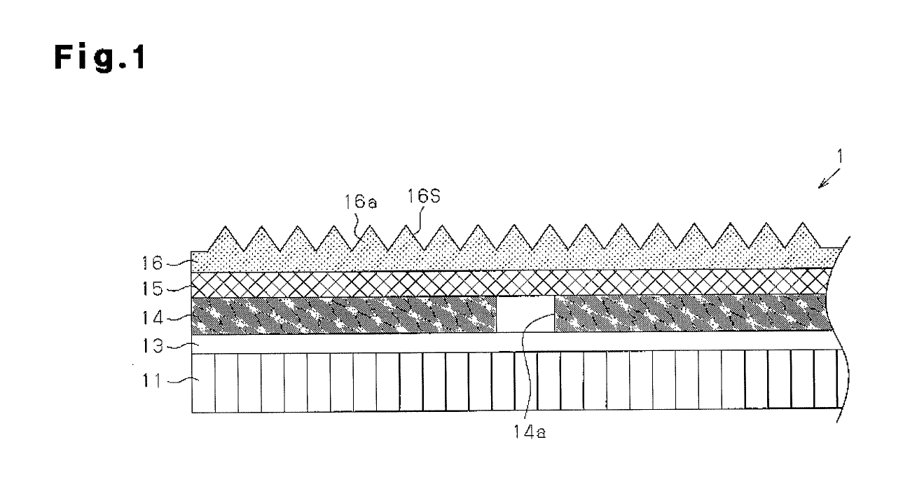

A touch panel sheet 1 according to one embodiment of the present invention will now be described with reference to FIG. 1.

The touch panel sheet 1 is arranged on a front side of a touchpad and includes a surface on which the finger of a user may be dragged. Although not illustrated in the drawing, electrodes and light emitting diodes (LEDs) are arranged at the inner side of the touch panel sheet 1.

As illustrated in FIG. 1, the touch panel sheet 1 includes a base sheet 11 and a plurality of printed layers 13 to 16 arranged on the base sheet 11. Resin printing is performed to form the printed layers 13 to 16.

The printed layer 13 arranged on an upper surface of the base sheet 11 is a white printed layer that transmits light. The white printed layer 13 may be, for example, a transparent or translucent white layer.

The printed layer 14 arranged on an upper surface of the white printed layer 13 is a black printed layer. The black printed layer 14 substantially blocks the transmission of light and may be, for example, a black layer. The blank printed layer 14 includes a symbol portion 14a at a location corresponding to a design or a character. The symbol portion 14a may be a transparent or translucent white layer that transmits light. The white printed layer 13 is one example of a first lighting layer, and the black printed layer 14 is one example of a second lighting layer. The symbol portion 14a is one example of a light transmission portion.

The printed layer 15 arranged on an upper surface of the black printed layer 14 is an ultraviolet (UV) block printed layer that blocks ultraviolet rays. The UV block printed layer 15 is formed by performing printing with an ultraviolet curing ink.

The printed layer 16 arranged on an upper surface of the black printed layer 15 is an irregular printed layer that includes irregularities. The irregular printed layer 16 is formed by performing printing with ultraviolet curing ink that contains beads 16a. Thus, the irregular printed layer 16 includes an ink printed surface 16S that contains the beads 16a. The ink printed surface 16S is an irregular surface formed by the beads 16a and serves as a surface of the touch panel sheet 1 on which the finger of the user may be dragged.

The UV block printed layer 15 is provided to ensure the distance between the irregular printed layer 16 and the base sheet 11. The UV block printed layer 15 and the irregular printed layer 16, which are formed by curing ultraviolet curing ink, have a high shielding effect and suppress the penetration of, in particular, sunscreens.

In the above structure, light from the LED (not illustrated) is diffused in the base sheet 11. The light passes through the white printed layer 13 and the symbol portion 14a of the black printed layer 14 and is emitted toward the user (upper side as viewed in FIG. 1). Thus, the light passing through the symbol portion 14a is recognized by the user as a symbol or character.

When a sunscreen is applied to the surface of the touch panel sheet 1, the irregular printed layer 16 suppresses the penetration of the sunscreen. Even if the sunscreen were to penetrate the irregular printed layer 16, the UV block printed layer 15 would not allow the sunscreen to reach the base sheet 11.

The UV block printed layer 15 and the irregular printed layer 16 also have a high shielding effect against cosmetics, grease, wax, cologne, hand creams, alcohol, and the like in addition to sunscreens.

The above embodiment has the advantages described below.

(1) The touch panel sheet 1 includes the base sheet 11 and the irregular printed layer 16 which is arranged above the base sheet 11. The irregular printed layer 16 includes the ink printed surface 16S that contains the beads 16a. The ink printed surface 16S is a surface including irregularities (surface of touch panel sheet 1) on which a finger may be dragged. That is, the beads 16a form the irregularities of the ink printed surface 16S. The irregularities improve the dragging feel. Further, the beads 16a allow for the irregularities to be formed more properly than when using a mold. This improves the dragging feel of the touch panel sheet 1.

(2) An ultraviolet curing ink is used to form the irregular printed layer 16. This improves the chemical resistance of the surface of the irregular printed layer 16 especially against sunscreens. The improvement in chemical resistance suppresses the penetration of chemicals through the irregular printed layer 16. Accordingly, swelling of the base sheet 11 does not occur since the penetration of chemicals through the irregular printed layer 16 is suppressed. This maintains the dragging feel of the touch panel sheet 1.

Further, in addition to sunscreens, the irregular printed layer 16 suppresses the penetration of chemicals that may be applied to the touch panel sheet 1 such as cosmetics, grease, wax, cologne, hand creams, and alcohol.

(3) The UV block printed layer 15 is arranged between the base sheet 11 and the irregular printed layer 16. The UV block printed layer 15 has a high chemical resistance especially against sunscreens. This further shields the base sheet 11 from chemicals and maintains the dragging feel of the touch panel sheet 1.

(4) Light may be emitted through the white printed layer 13 and the symbol portion 14a of the black printed layer 14. This allows for the user to recognize a symbol or character that appears on the surface of the touch panel sheet 1.

(5) The beads 16a are used to form irregularities on the touch panel sheet 1. This allows for the formation of fine irregularities in correspondence with the diameters of the beads 16a.

It should be apparent to those skilled in the art that the present invention may be embodied in many other specific forms without departing from the spirit or scope of the invention. Particularly, it should be understood that the present invention may be embodied in the following forms.

The UV block printed layer 15 in the above embodiment may be omitted. In this case, the irregular printed layer 16 is directly stacked onto the black printed layer 14.

Further, when lighting is unnecessary, the white printed layer 13 and the black printed layer 14 may be omitted. In this case, the UV block printed layer 15 may also be omitted. In other words, the irregular printed layer 16 may be directly stacked onto the base sheet 11. The omission of the printed layers 13 to 15 allows for the touch panel sheet 1 to be thin.

In the above embodiment, the irregular printed layer 16 and the UV block printed layer 15 are each formed from an ultraviolet curing ink. However, other inks, such as a one-component type ink or a two-component mixture type ink may be used to form the irregular printed layer 16 and the UV block printed layer 15.

The UV block printed layer 15 may have the function of the black printed layer 14. In this case, the black printed layer 14 may be omitted. Alternatively, the black printed layer 14 may have the function of the UV block printed layer 15. In this case, the UV block printed layer 15 may be omitted. According to these modifications, the touch panel sheet 1 may be formed in a more simple structure.

The present examples and embodiments are to be considered as illustrative and not restrictive, and the invention is not to be limited to the details given herein, but may be modified within the scope and equivalence of the appended claims.

1. A touch panel sheet comprising:
a base sheet; and
an irregular printed sheet arranged above the base sheet, wherein the irregular printed layer includes an ink printed surface that serves as an irregular surface on which a finger may be dragged, and the ink printed surface contains beads.

2. The touch panel sheet according to claim 1, wherein the irregular printed layer is an ultraviolet curing ink printed layer.

3. The touch panel sheet according to claim 1, further comprising:
an ultraviolet block printed layer arranged between the base sheet and the irregular printed layer, wherein the ultraviolet block printed layer is an ultraviolet curing ink printed layer.

4. The touch panel sheet according to claim 1, further comprising:
a first lighting layer that transmits light;
a second lighting layer that substantially does not transmit light, wherein the second lighting layer is arranged between the first lighting layer and the irregular printed layer and includes a light transmission portion that transmits light, and the light transmission portion is arranged at a location corresponding to a design or a character.

5. The touch panel sheet according to claim 4, wherein
the first lighting layer is a white printed layer that is transparent or translucent white,
the second lighting layer is a black printed layer, and
the light transmission portion is a transparent or translucent white layer.
